(19) United States
(12) Patent Application Publication
(10) Pub. No.: US 2006/0212476 A1
(43) Pub. Date: Sep. 21, 2006

(54) Method and apparatus for tracking candidate referrers

(76) Inventors: Phillip Lee Bogle, Bellevue, WA (US); Eric Brendan Kennedy, Seattle, WA (US); Ethan James Lowry, Seattle, WA (US)

Correspondence Address: HELLER EHRMAN WHITE & MCAULIFFE LLP, 1717 RHODE ISLAND AVE, NW, WASHINGTON, DC, 20036-3001, US

(21) Appl. No.: 11/082,950

(22) Filed: Mar. 18, 2005

(51) Int. Cl. G06F 17/00

(52) U.S. Cl. 707/104.1

(57) ABSTRACT

A method and apparatus for tracking candidate referrers is provided. Preferably, the method includes steps of and/or apparatus performs steps of receiving a candidate referral from a referrer, monitoring activity involving the candidate referral, and updating a referrer rating of the referrer based on the monitored activity.

### CORRESPONDING RELATED APPLICATIONS

This application is related to co-pending applications entitled “METHOD AND APPARATUS FOR IDENTIFYING CANDIDATES FOR A POSITION” and “METHOD AND APPARATUS FOR RANKING CANDIDATES”, both of which were filed simultaneous with the present application. The present application incorporates by reference the entire contents of these two applications in their entirety.

### BACKGROUND OF THE INVENTION

1. Field of the Invention

The present invention relates generally to tracking candidate referrers, and in particular to methods and apparatuses that update a referrer rating based on monitored activity.

1. Description of the Related Art

Methods and apparatuses involving job searching and placement services are known in the art. Such methods and apparatus are offered, for example, on well known Internet Web sites including www.Monster.com, www.Linkedln.com, www.HotJobs.com, and www.RealContacts.com. Another such method is described in U.S. Published Patent Application No. 2004/0107192, which is incorporated by reference herein in its entirety.

The '192 application, similar to many known methods and apparatuses, discloses a method for providing job searching services, recruitment services and/or recruitment-related services (¶[0002]). In particular, the '192 application discloses a database 10H which contains employer data (¶[0130]), applicant data (¶[0124]) and recruiter data (¶[0136]). Specific examples of stored data include resumes, references, educational background, etc. The '192 application also discloses methods for restricting access and filtering employee or employer queries, such as preventing current employers from accessing information regarding their current employees (¶[0127]), and tracking applicants that are pre-approved or prohibited for working for a particular employer (¶[0135]).

The '192 application and other known methods and apparatuses, however, fail to adequately filter prospective candidates or reach passive prospective candidates (i.e., those not presently actively seeking jobs). As such, the company or recruiter looking for prospective candidates may be inundated with resumes, many of which are not close to the type or quality of candidates the company or recruiter is looking for. Thus, a need exists for an improved method and apparatus for identifying candidates for job openings, and for tracking and evaluating candidate referrers to better rank prospective candidates.

Other problems with the prior art not described above can also be overcome using the teachings of the present invention, as would be readily apparent to one of ordinary skill in the art after reading this disclosure.

### BRIEF DESCRIPTION OF THE DRAWINGS

FIG. 1 is a flowchart of a method of identifying candidates for a position according to an embodiment of the present invention.

FIG. 2 is a flowchart of a campaign creation process according to an embodiment of the present invention.

FIG. 3 is a flowchart of a message personalization process according to an embodiment of the present invention.

FIG. 4 is a flowchart of a contact identification process according to an embodiment of the present invention.

FIG. 5 is flowchart of a profile maintenance process according to an embodiment of the present invention.

FIG. 6 is flowchart showing campaign information flow from a system to referrers and candidates, and back to the system according to an embodiment of the present invention.

FIG. 7 is a flowchart of a method for ranking profiles according to an embodiment of the present invention.

FIG. 8 is a flowchart of a method of selecting positions for a candidate according to an embodiment of the present invention.

FIG. 9 is block diagram of a system useable with various methods of the present invention.

FIG. 10 is a screen shot of a profile creation process according to an embodiment of the present invention.

FIG. 11 is a screen shot of a profile management process according to an embodiment of the present invention.

FIG. 12 is a screen shot of a campaign management process according to an embodiment of the present invention.

FIG. 13 is a screen shot of a campaign recipient adding process for use with a previously created campaign according to an embodiment of the present invention.

FIG. 14 is a screen shot of a campaign recipient adding process for use with a newly created campaign according to an embodiment of the present invention.

FIG. 15 is a screen shot of a job description process for use in creating a campaign record according to an embodiment of the present invention.

FIG. 16 is a screen shot of an exemplary email response template from a candidate according to an embodiment of the present invention.

FIG. 17 is a screen shot of an exemplary personalized email template to a contact according to an embodiment of the present invention.

FIG. 18 is a screen shot of a campaign management process showing received candidate profiles ranked by predicted prospect rating (PPR) according to an embodiment of the present invention.

FIG. 19 is a screen shot of a recommendation adding process according to an embodiment of the present invention.

FIG. 20 is a flowchart of a method for calculating the PPR for a candidate according to an embodiment of the present invention.

### DETAILED DESCRIPTION OF THE EXEMPLARY EMBODIMENTS

Reference will now be made in detail to exemplary embodiments of the present invention. Wherever possible, the same reference numbers will be used throughout the drawings to refer to the same or like parts.

Various embodiments of the present invention are directed at relationship-based networks that connect employers (e.g., companies, educational institutions, government municipalities, etc.) with skilled labor in a job placement context. For discussion purposes, skilled labor can also be referred to as “candidates” or “prospects” for a position with an employer. As would be readily understood by those of skill in the art, skilled labor may include, for example, (1) independent contractors; (2) third party applicants; and (3) existing employees of that employer, such as employees that are employed in a different position than the one being applied for. Other forms of skilled labor are also contemplated.

In addition to the job placement context, the present invention may be used to connect entities in a service or product procurement context. As an example, Company A (a nominal employer) may use one or more embodiments of the present invention to identify Company B (a prospect/candidate) for supplying widgets to Company A. Other applications are also contemplated.

According to one embodiment of the present invention, a method of identifying candidates for a position is disclosed. Preferably, the position is defined in a campaign for the position. In the job placement context, a campaign may comprise a record containing at least a job description, a candidate requirement, and a contact for the campaign. The purpose of the campaign is to identify candidates for the position. Embodiments directed at campaign creation are provided below.

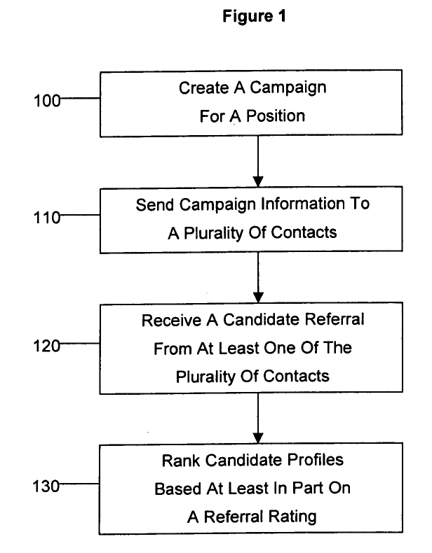

In step 100 (FIG. 1), a campaign for a position is created by a recruiter, a hiring manager, or any other entity with information regarding the position. As an example, a recruiter may create in step 100 a campaign for a position with an employer that is a client of the recruiter. Similarly, a hiring manager at an employer may create in step 100 a campaign for a position with the employer. For discussion purposes, the recruiter, hiring manager or other entity involved in creating the campaign or for which the campaign is created (e.g., a client company) can be referred to as a “campaign creator”. It should be appreciated that a campaign creator may create in step 100 a single campaign for a single position, a single campaign for multiple positions, or multiple campaigns for multiple positions.

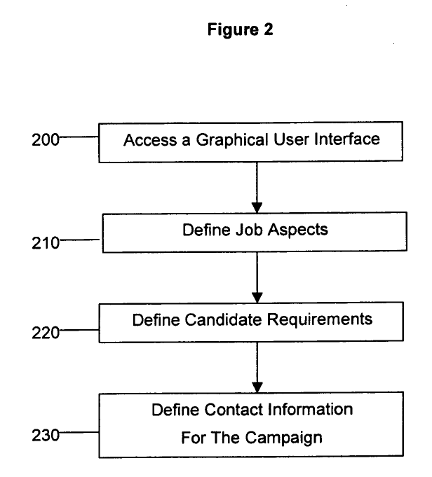

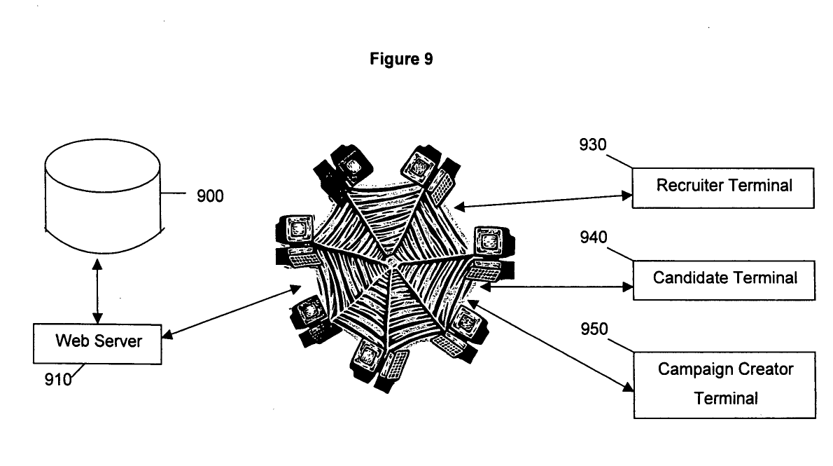

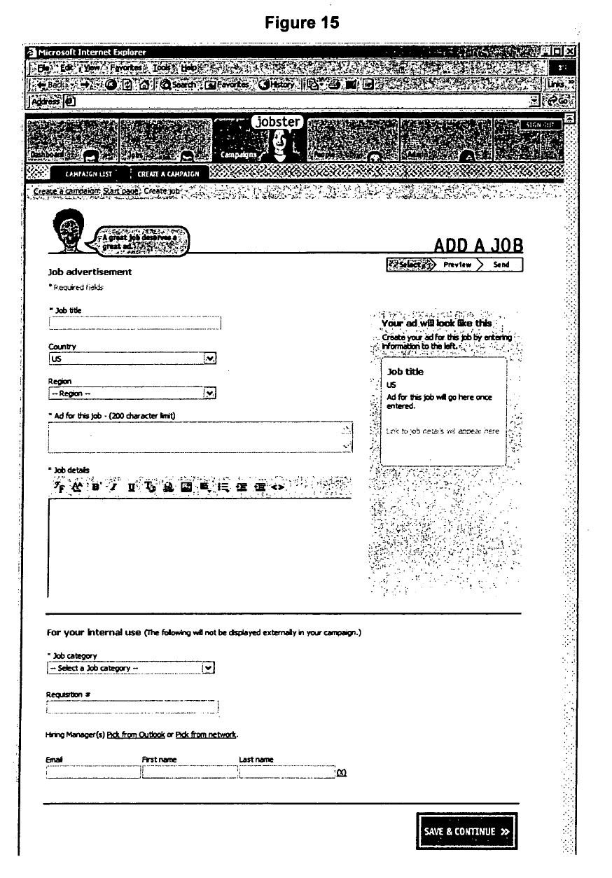

The campaign creator may create a campaign in step 100 by generating a record including information about the campaign. This record generation may take place, for example, by accessing a graphical user interface (GUI) or the like in step 200 (FIG. 2) to enter information about the campaign into a database 900 (FIG. 9). As an example, a user may access the GUI in step 200 to perform tasks such as defining job aspects (step 210), defining candidate requirements (step 220), and defining contact information for the campaign (step 230). This defined data is then stored as a record in a database 900. See, for example, the screen shot of FIG. 15 which shows a job description process as part of creating the noted campaign record.

According to one embodiment of the present invention, job aspects include company description, job location, job responsibilities, and salary range. According to another embodiment of the present invention, candidate requirements include employment history and educational background. Other information may also be provided, as would be readily understood by those of skill in the art after reading this disclosure.

Once the record has been created for the campaign in step 100, the campaign is published in such a manner that it becomes visible to entities other than the campaign creator. As an example, a representation of all or a portion of the campaign record may be made publicly available on a job postings Web site and/or sent to a plurality of contacts. Campaign publishing may publish complete campaign records, partial campaign records, or non-record information (e.g., a banner advertisement with links to a campaign record on a job postings Web site)—collectively referred to as published “campaign information”. Embodiments directed at publishing campaign information are provided below.

According to one embodiment of the present invention, campaign information is published by sending in step 110 (FIG. 1) the campaign information to a plurality of contacts. Sending campaign information in step 110 may comprise, for example, transmitting a campaign email to at least one contact (e.g., a candidate or candidate referrer), and/or appending campaign information as a signature to an outgoing message (e.g., to an email addressed to a candidate or candidate referrer, or to any outgoing message regardless of addressee). Preferably, campaign information is sent in step 110 to a plurality of contacts in addition to other campaign publication techniques.

According to another embodiment of the present invention, messages sent in step 110 may be personalized for each contact or class of contact. Personalization allows for the system to take into consideration differences between various contacts. To illustrate, a prospective candidate may desire detailed information about the company description and working environment, whereas a recruiter may desire only information involving basic job requirements and salary range. The present invention contemplates several different methods for personalizing campaign information as described in greater detail below.

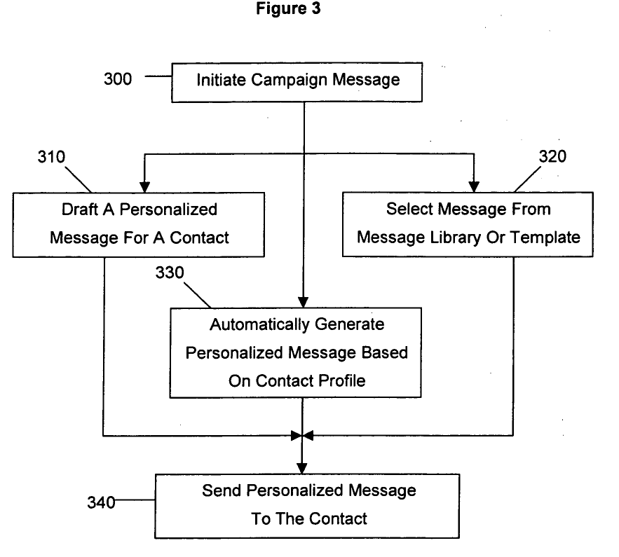

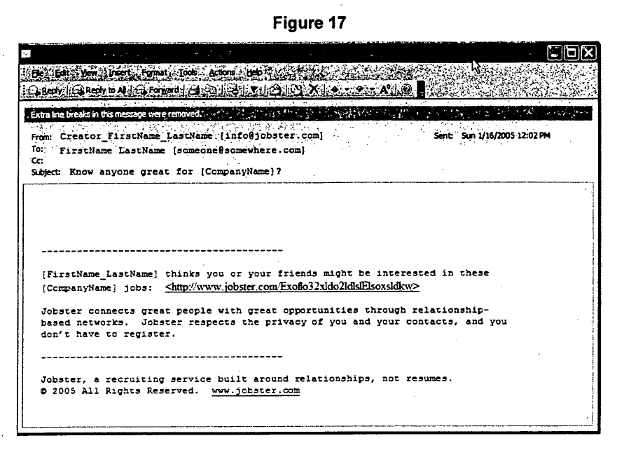

According to one embodiment, the campaign creator may initiate a personalized campaign message in step 300 (FIG. 3) for a given candidate or referrer. As an example, a recruiter may draft a personalized message in step 310 that highlights aspects of the campaign for a particular candidate the recruiter has worked with in the past. Similarly, the campaign creator may select in step 320 a message from a library of previously sent messages or a template from a library of templates. As an example, a recruiter may select a first message type directed at candidates the recruiter has worked with in the past and a second message type directed at candidates the recruiter has not worked with in the past. Additionally, the system may automatically generate in step 330 a personalized message based on a contact's profile. As an example, the system may use the profile to guide the system in selection of an appropriate message, such as a first message is selected for all candidates and a second message is selected for all referrers. Personalized messages may be created using any one of or a combination of steps 310, 320, 330, and then sent in step 340 to the contacts or class of contacts for whom the personalized messages are created. Other examples of personalization are also contemplated. See, for example, the screen shot of FIG. 17, which shows an exemplary personalized email template to a contact.

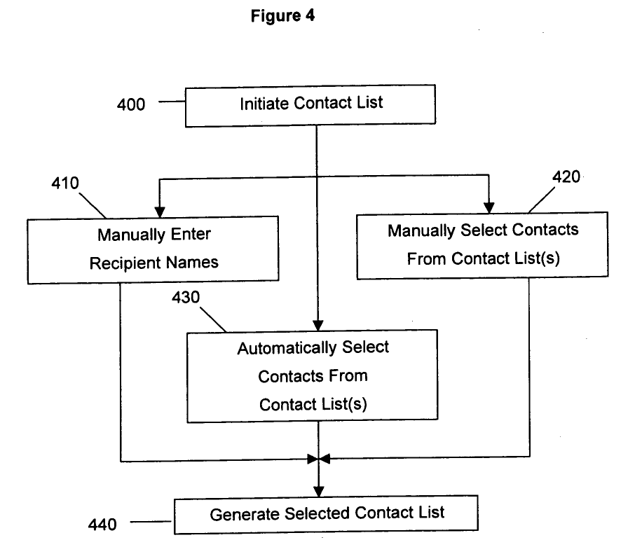

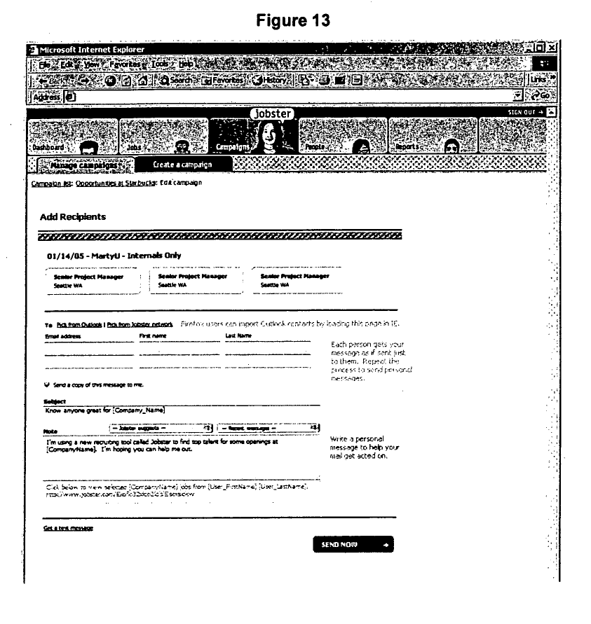

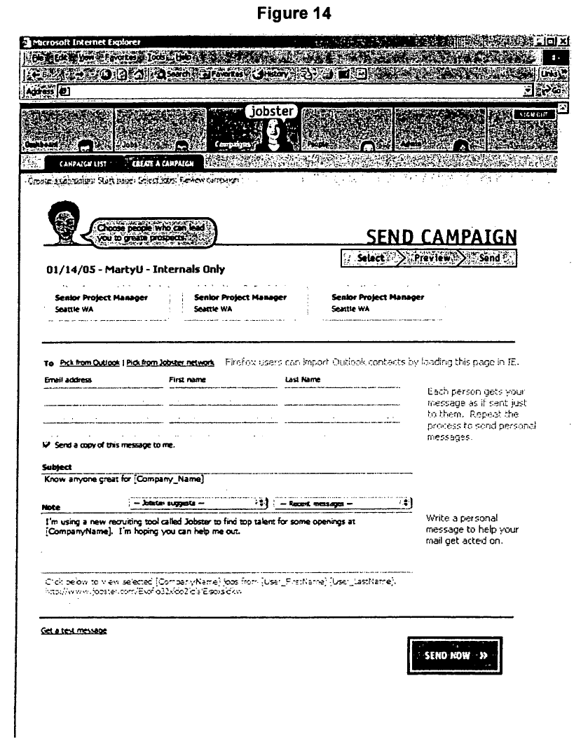

As previously described, campaign information is preferably sent in step 110 to at least one contact, and, in some applications, messages sent to the contact(s) may be personalized for that contact or class of contact (steps 300, 310, 320, 330, 340). Contacts are entities that are known or identified prior to or contemporaneous with publishing the campaign. Contacts may include candidates for the position and/or candidate referrers that refer candidates for the position. Preferably, contacts are identified by the campaign creator or system initiating a contact list in step 400 (FIG. 4). Initiating a contact list in step 400 may comprise, for example, the campaign creator using Microsoft Outlook or another similar program interface to perform one or more of steps 410, 420, 430 as would be readily understood by those of skill in the art. Contacts are then identified by: (1) manual entry (e.g., the campaign creator directly entering recipient names) in step 410; (2) manual selection (e.g., the campaign creator selecting contacts from a subscription list of skilled labor asking to be contacted when a position becomes available, a list of candidates for prior or co-existing campaigns, an automatically generated list, etc.) in step 420; (3) automatic selection by the system (e.g., by comparing profiles to requirements as described in later embodiments) in step 430; or (4) any combination of steps 410, 420, 430. Once identified, the system may then generate a selected contact list in step 440, the contact list being those contacts that receive campaign information via step 110. See, for example, the screen shots of FIGS. 13 and 14, which show a campaign recipient adding process.

According to one embodiment of the present invention, candidate and/or referrer profiles are maintained to supplement the contact identification process. As previously noted, candidates and referrers represent two classes of contacts that may be contacted by the system, where candidates represent prospects for the job and referrers represent entities likely to refer prospects for the job. Candidate and referrer profile maintenance is discussed individually below, as different information may be pertinent to candidates and referrers.

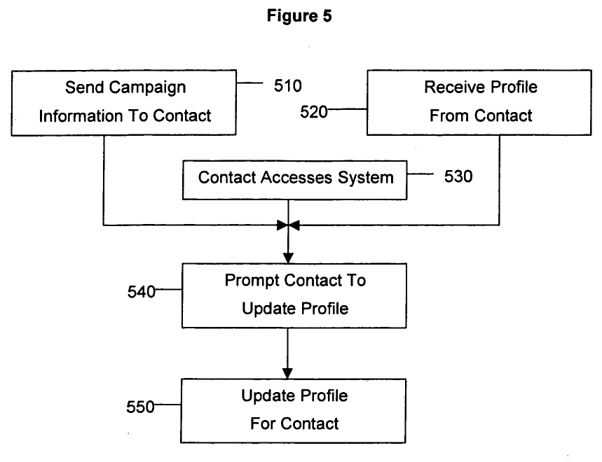

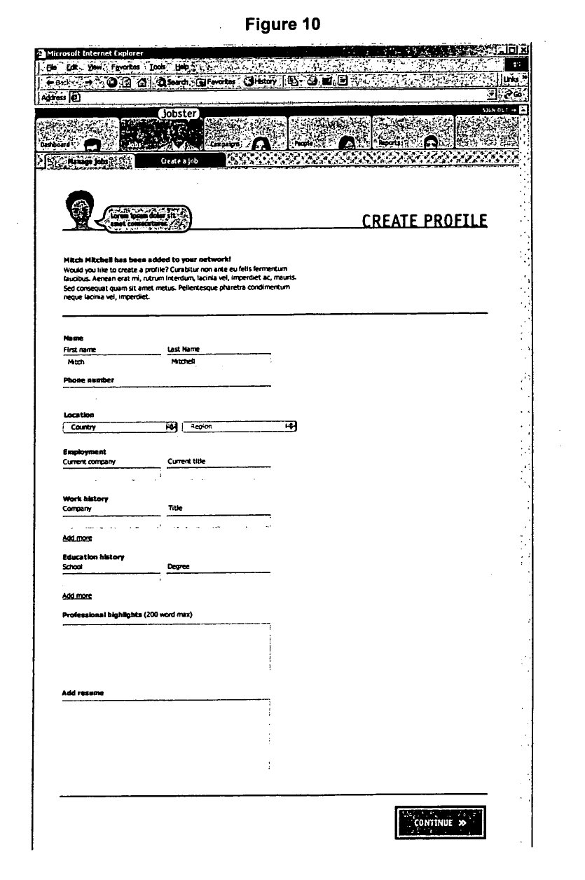

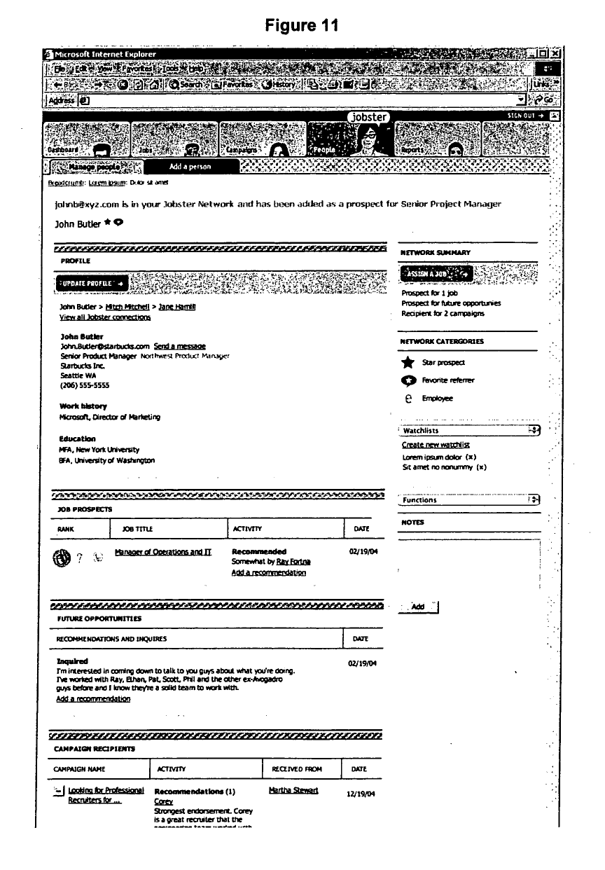

Candidate profiles may be maintained to supplement the identification of candidate contacts for the campaign. A Web site or other software may maintain a plurality of candidate profiles, including information such as employment history, educational background, preferred job aspects, contact information, etc. Preferably, the system includes a method of maintaining or updating candidate profiles over time as shown in FIG. 5. As an example, each time a message is sent to a candidate (step 510), each time a candidate accesses the system (step 530), and/or each time a profile is received from a candidate (step 520), the candidate may be prompted in step 540 to update contact information if needed. The system then updates the candidate profile in step 550 with information provided in response to step 540. This helps facilitate future communications with the contact and the relevance of campaigns identifying the candidate as a contact for campaign information. See, for example, the screen shots of FIGS. 10 and 11. FIG. 10 shows one example of a profile creation process. FIG. 11 shows one example of a profile management/updating process.

Using the profile information described above, candidates for a position may be automatically identified by the system in step 430 by comparing defined job aspects in the campaign to information in the candidate profiles. If set aspects are met, such as X profile has a sufficient educational background and employment history match to defined campaign aspects, the candidate with X profile is identified as a contact for campaign information.

Filters may be included as part of performing step 430 (FIG. 4) such that the candidate or campaign creator can prevent certain campaigns from being sent to certain candidates. As an example, an employee X who left employer Y in the past may request blocking of any campaigns involving employer Y. Other filters are also contemplated.

Similar to candidate profiles, candidate referrer profiles may be maintained to supplement the identification of candidate referrers for the campaign. A Web site may maintain a plurality of referrer profiles, including referral history and contact information. Referrers may include, for example, any entity that has referred candidates in the past or has the potential to refer candidates in the future. To illustrate, referrers may include individuals on a corporation's employee list (e.g., an email contact list), a list of recruiters, a list of recruiter agencies, a list of temporary staffing providers, etc.

Referrers may be known in advance or identified using Internet searching and sourcing technology or the like. As an example, referrers for a position may be identified in step 430 by comparing defined job aspects in the campaign to the candidate referrer profiles, and/or based on a referrer rating for each referrer. If set aspects are met, such as X profile has position in the company that matches defined campaign aspects and the candidate referrer has a referrer rating of at least Y, the candidate referrer with X profile is identified as a contact for campaign information in step 430. Additional disclosure regarding the referrer rating is provided below in reference to determining a candidate's referral rating.

Once contacts have been identified and a selected contact list generated (step 440), the campaign information can then be sent in step 110 (FIG. 1) to those identified contacts (i.e., candidates and/or referrers) as previously described. Dissemination of campaign information may be supplemented by also publishing the campaign information in other ways. As an example, it is contemplated to post campaign information as a banner advertisement on a Web site. Additionally, it is contemplated to post campaign information on a job postings Web page, such as www.Monster.com, providing it in a discussion forum or blog, etc. Preferably, such dissemination is still targeted, however, to a particular group of perspective candidates or referrers, such as to a specific blog having characteristics in common with the campaign record. One of ordinarily skill in the art will appreciate after reading this disclosure that various methods for publishing campaign information may be used individually or in combination to disseminate the campaign information.

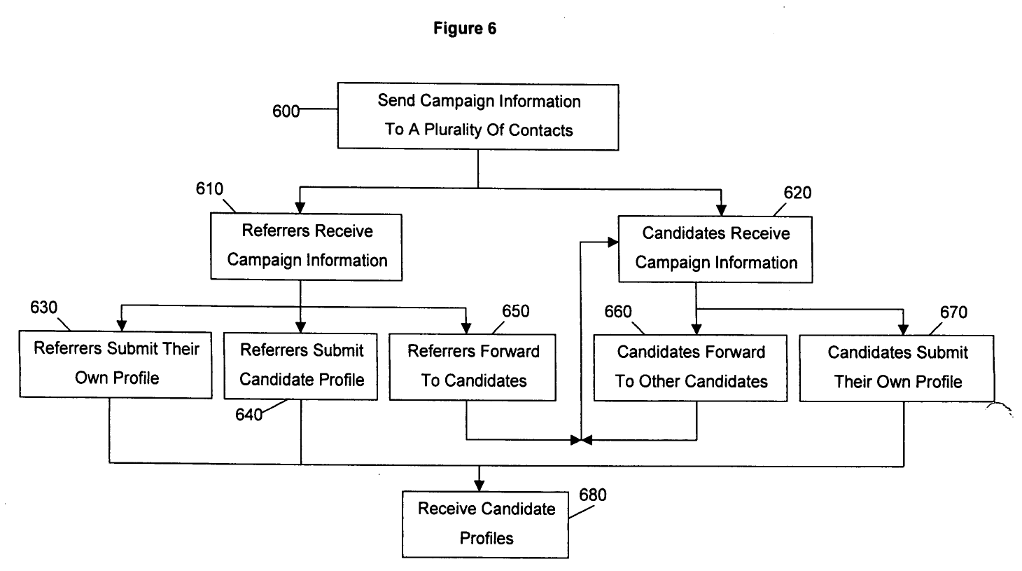

Once the campaign information has been published, the system may receive candidate profiles in step 120 (FIG. 1), 680 (FIG. 6) from any number of sources. Preferably, the campaign information is sent in step 110, 600 to a plurality of contacts. Referrers receive the campaign information in step 610, from sent campaign information in step 600 and campaign information published by other means. Referrers may perform a number of steps once campaign information has been received in step 610. Referrers may submit a candidate referral in step 640 (or a plurality of candidate referrals, such as a recruiter responding to a company's campaign) directly to the system, forward the campaign information to another referrer or candidate in step 650, or submit their own profile for the campaign (i.e., the referrer may himself/herself become the candidate) in step 630.

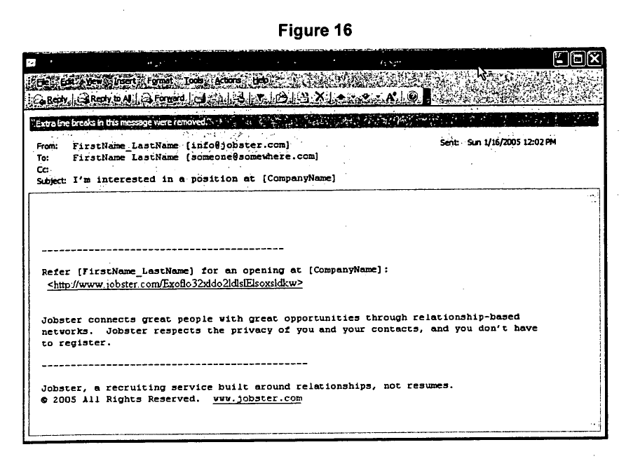

Candidates receive the campaign information in step 620, from sent campaign information in step 600, from forwarded messages in step 650, or from other publication means. As with the referrers, candidates may also perform many actions. To illustrate, candidates may forward the campaign information to other candidates in step 660, or submit their own profile in step 670. Other actions taken by candidates and/or referrers are also contemplated. See, for example, the screen shot of FIG. 16, which shows an exemplary email response template from a candidate.

Once candidates and referrers have taken some action on the campaign information, the system then receives candidate profiles in steps 120, 680. This includes profiles sent to the system from referrers in step 630, 640 and from candidates in step 670. In addition, the system may also review candidate profiles already stored on the system, such as candidates who responded to other campaigns in the past. Thus, the system may receive campaign profiles in step 680 from a plurality of internal and external sources.

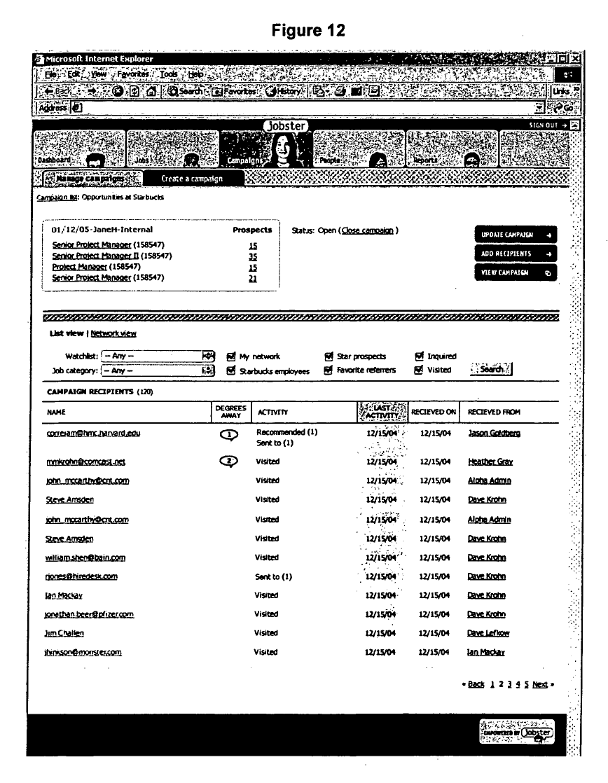

According to one embodiment of the present invention, the system also tracks campaign information recipients as part of the sending campaign information in step 110 (FIG. 1). As an example, the system may track a chain of connections to each campaign information recipient. If the campaign information is originally sent to contact X, and contact X forwards the information to entity Y, the system may add entity Y to the contact list for future reference. In some applications, each link along the chain of communications may be prompted to create or update a profile (i.e., a candidate and/or referrer profile) for future reference. In this manner, the system can use the communications themselves to improve the publication of future campaigns and the relevancy of candidate profiles received by the system. See, for example, the screen shot of FIG. 12, which shows activity taken by campaign recipients.

While the collection of candidate profiles itself (steps 110, 120, 130) as described in the previous embodiments is useful, one significant problem with existing systems is the inundation of candidate profiles with many that are of poor quality. Thus, one embodiment of the present invention is directed at ranking candidate profiles in step 130 that have been received and/or reviewed by the system.

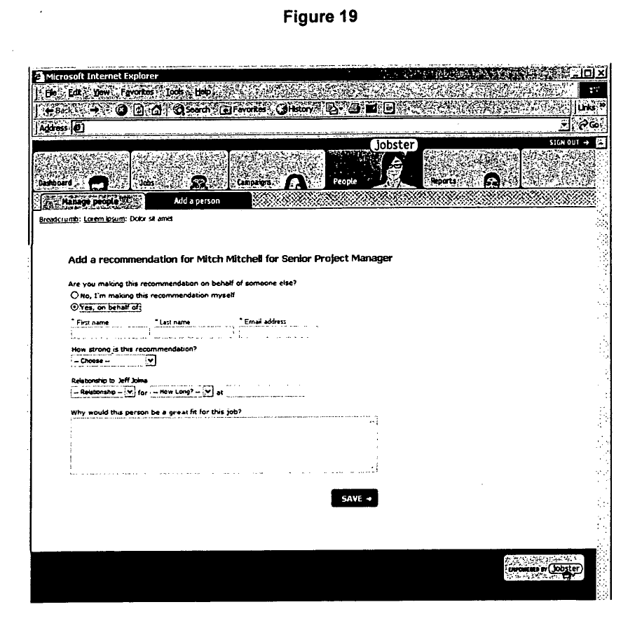

Candidate profiles may be ranked in step 130 based on a candidate profile rank. The candidate profile rank generally refers to the strength of a given candidate's profile in comparison to other candidates. Many factors may be weighed in arriving at the candidate profile rank for a given candidate profile. One factor used in determining a candidate profile rank is a candidate referral rating. A candidate referral rating may be defined as the overall strength of references for that candidate. Examples of determining a candidate referral rating are provided below. See also the exemplary screen shot of FIG. 19, which shows a recommendation adding process useable with the present embodiment.

As one example, assume a campaign is sent to Employee X, and Employee X recommends a former classmate Candidate Y. Assume further that Candidate Z applies directly for the same position that Candidate Y was recommended for. Candidate Y may be given a higher referral rating than Candidate Z because Candidate Y received a referral, whereas Candidate Z did not. This factor can be referred to as the “Source” factor.

As another example, assume a campaign is sent to Employee A, who is an assistant manager, and Employee B, who is a teller. Assume further that Employee A recommends Candidate Y and Employee B recommends Candidate Z. Candidate Y may be given a higher referral rating than Candidate Z, because Employee A has a greater impact on the hiring decisions of the company than Employee B. This factor can be referred to as the “Hiring Manager” factor.

As another example, assume a campaign is sent to both Employee F and Employee G. Assume further that Employee F recommends Candidate Y, who Employee F supervised at a prior employer. Assume further that Employee G recommends Candidate Z, who Employee G heard speak at a conference but never worked with. Candidate Y may be given a higher referral rating than Candidate Z, due to the knowledge of the candidates'work. This factor can be referred to as the “working knowledge” factor.

As another example, assume a campaign is sent to both Employee M and Employee N. Assume further that Employee M strongly recommends Candidate Y, and Employee N mildly recommends Candidate Z. Candidate Y may be given a higher referral rating than Candidate Z, due to the strength of the referral itself. This factor can be referred to as the “recommendation strength” factor.

As another example, assume a campaign is sent to Referrer R. Assume further that Referrer R refers a candidate, with Referrer R being “D” degrees away from the company. The weighting factor can then be multiplied by a score of 0.5^{d}. If d=0, i.e., the recommendation is provided by an employee of the company then this multiplier is just 1. If the recommendation is provided by someone distanced from the company than=>if d=1, then this multiplier is 0.5. If d=2, then this multiplier is 0.25. This factor can be referred to as the “connection and distance” factor.

According to one embodiment of the present invention, the aforementioned factors are weighted and summed to achieve a net score for a candidate. One exemplary weighting structure is provided in the table below. Other weightings are also contemplated.

TABLE 1

| | Weighting |
|---|---|
| Factor | (multiplier) |
| Indirect working knowledge | 0.5x |
| No direct working knowledge | 0.1x |
| Hiring manager | 1.5x |
| Non-hiring manager | 1.0x |
| Referred candidate (source from | 1.0x |
| referral) | |
| Direct candidate (source not from | 0x |
| referral) | |
| Strong recommendation strength | 1.0x |
| Neutral recommendation strength | 0.75x |
| Weak recommendation strength | 0.5x |
| Connection and distance = d | 0.5^{d}x |

As disclosed above, a candidate's recommendations are summed and weighted. Preferably, referrer ratings of the referrers themselves may also be calculated and balanced against the candidate's recommendations to achieve an overall candidate referral rating. However, it should be appreciate that a candidate's referral rating may be on the recommendations alone, the referrer rating alone, or a combination of the recommendations and referrer rating. Embodiments directed at calculating a referrer rating are provided below.

A referrer rating preferably is based on a plurality of factors such as a position of the referrer within a company, a referral history of the referrer, etc. As an example, if a hiring manager is the ultimate decision maker for filling a position and that hiring manager recommends a candidate, the referrer rating is preferably given a high value indicating the strength and importance of the referrer. This is similar to the Hiring Manager factor previously described.

In addition, if a particular referrer has a strong referral history, the referrer rating is also preferably given a high value indicating the past success of this particular referrer. A referral history may be defined as any action involving the treatment of candidates previously referred by the referrer. Exemplary actions involve a hiring rate of referred candidates, an interview rate of referred candidates, and a review rate of referred candidates. A review rate of referred candidates may be defined as the rating given to referred candidates by the campaign creator.

As with the recommendations for the candidate, these factors involved in determining a referrer rating may also be weighted. One exemplary weighting structure is provided in the table below. Other weightings are also contemplated.

TABLE 2

| Referral History | Weighting (Integer value) |
|---|---|
| Received an offer | +4 |
| Been interviewed | +2 |
| Rated a prospect to follow up on by | +1 |
| campaign creator | |
| Rated an average prospect by | 0 |
| campaign creator | |
| Rated a prospect not worth pursuing | −1 |
| by campaign creator | |

According to one embodiment of the present invention, the weightings of a given referrer's referral history are added together to determine a net score. A “batting average” is then calculated by dividing the net score by the total number of rated recommendations for that referrer. As an example, if the if Referrer X has referred three candidates in the past, Candidates A, B, C, and Candidate A was hired, Candidate B was rated an average prospect by the campaign creator, and Candidate C was rated a prospect not worth pursuing by the campaign creator, the calculation would be=>(4+0−1)/3=1.

According to one embodiment of the present invention, for each recommendation a candidate receives, the weighted sum for that recommendation is then multiplied by the referral rating (i.e., the batting average) for that particular referrer. This process may be used for each recommendation, and the results totaled to achieve a net candidate referral rating.

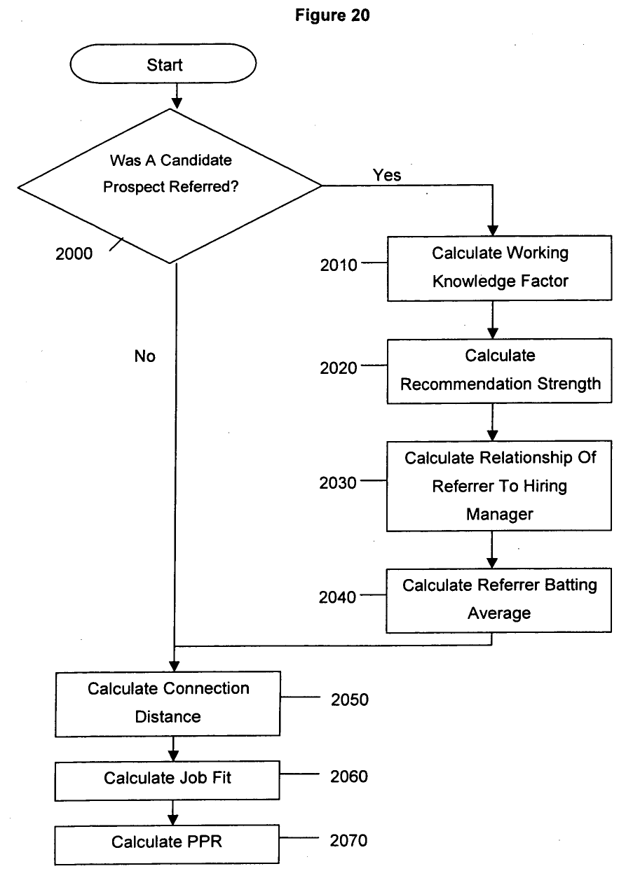

In particular, a method for calculating the PPR for a candidate is shown in the flowchart of FIG. 20. This method may start automatically when a given candidate profile is received, when all candidate profiles have been received, upon user initiation, immediately prior to ranking candidate profiles (as will be described in embodiments below), etc. Once started, the method determines in step 2000 whether a candidate prospect was referred (e.g., whether a referrer submitted the candidate's profile). Alternatively, step 2000 may comprise determining whether a candidate received any recommendations, such as a candidate submitting their own profile with corresponding recommendations included therein or received thereafter.

If the candidate prospect was referred, the method proceeds to steps 2010 through 2040. It should be appreciated that steps 2010, 2020, 2030 and 2040 may be performed in any order, and/or may be performed simultaneously depending on the particular implementation at hand. Thus, the order shown is purely for description purposes only.

In step 2010, the method calculates a working knowledge factor for the referral. In step 2020, the method calculates a recommendation strength for the referral. In step 2030, the method calculates a relationship of the referrer to the hiring manager. And finally, in step 2040, the method calculates a referrer batting average for the referrer. The factors calculated in steps 2010, 2020, 2030 and 2040 are analogous to factors previously described, and exemplary weightings provided in Table 1 and Table 2.

Irregardless of whether the candidate was referred, the method in step 2050 calculates a connection distance between the candidate and the company. The method then calculates in step 2060 a job fit, such as by comparing a candidate profile to a campaign record. Finally, in step 2070 the method calculates the PPR using the outcome of steps 2010, 2020, 2030, 2040, 2050 and 2060. This PPR can be used to rank and/or group candidates as will be described in greater detail below.

As described above, for each candidate a candidate referral rating (preferably part of an overall PPR) is determined. Candidate profiles may be ranked and/or grouped based wholly on the candidate referral ratings. As an example, candidates may be grouped into three categories: (1) Strong Prospects; (2) Average Prospects; and (3) Poor Prospects. Preferably, grouped candidate profiles are also ranked within each group based on the candidate referral rating. The automatic ranking or grouping of candidates can be referred to as the predicted prospect ranking (PPR), as it is predictive of the likelihood of acting on a given candidate. This process is described in greater detail below.

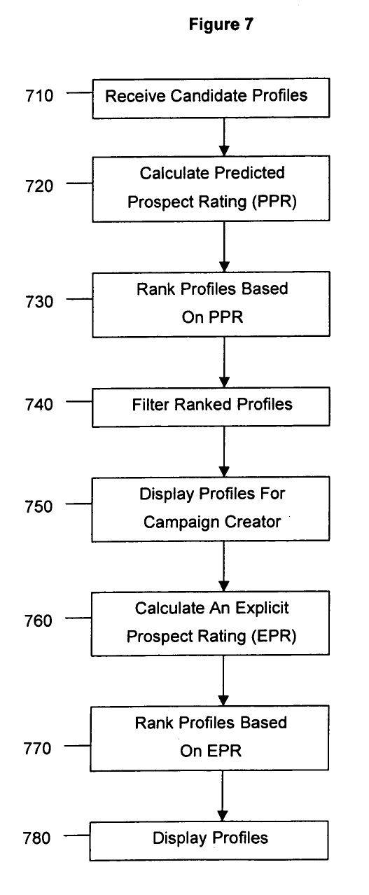

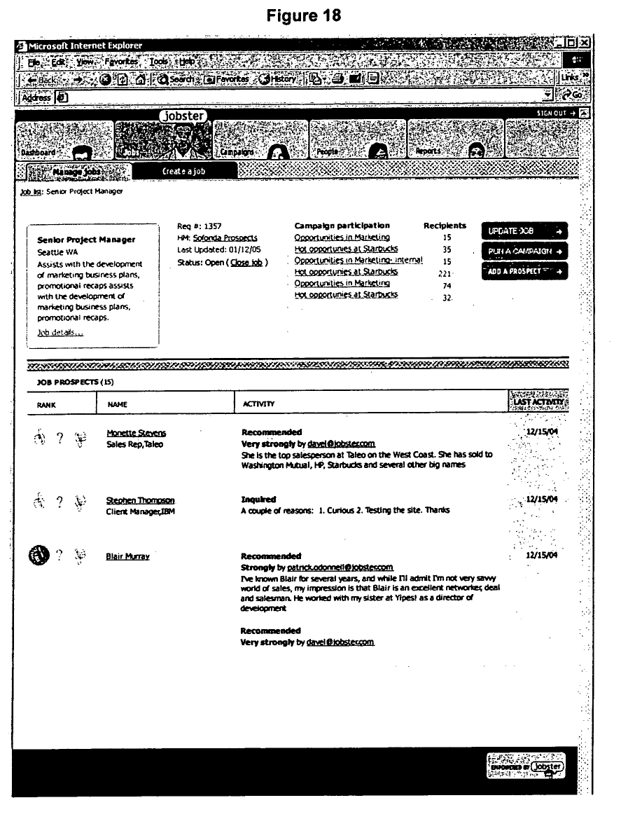

In step 710 (FIG. 7), candidate profiles are received in a similar manner as described in reference to steps 120, 680. The system then calculates a PPR in step 720 for each profile received in step 710. Step 720 may be performed using the aforementioned techniques described for calculating a candidate referral rating. In step 730, the system then ranks profiles based on the PPR calculated in step 730. If provided, filters may be used in step 740 to filter the ranked profiles, such as discarding profiles corresponding to prior employees of a given employer. The filtered profiles are then displayed in step 750 for the campaign creator or other reviewer of the candidate profiles. Step 750 may comprise, for example, a screen depicting an ordered list of candidate profiles with strong prospects having a thumbs up next to their profile, average prospects having a thumbs across/sideways next to their profile, and poor prospects having a thumbs down next to their profile. Other techniques for displaying the filtered profiles are also contemplated. See, for example, the screen shot of FIG. 18, which shows received candidate profiles ranked by PPR.

According to another embodiment of the present invention, the PPR calculation in step 730 also incorporates a comparison of candidate profiles to campaign requirements. As an example, candidates with close matches between educational background and education requirements in the campaign record may be given a higher PPR than candidates with lower matches. Similarly, candidates that are willing to move to a location in which the job is located may be given a higher PPR than candidates that have indicated an unwillingness to move. These factors can be determined by comparing the candidate profiles to the campaign record.

As described above, the disclosed method includes techniques for identifying candidates for a position by sending campaign information to a plurality of contacts (step 110), receiving candidate referrals from the plurality of contacts (step 120), and ranking candidate profiles based on candidate profile ranks (step 130) wherein the candidate profile ranks are based at least in part on a referral rating. Such a process may be done largely automatically by a system used to create the campaign.

It is further contemplated, however, to provide a second ranking of candidate profiles referred to as an explicit prospect rating (EPR). Specifically, once the system has ranked or grouped candidate profiles based on PPR in step 730, the campaign creator or other reviewer may further manually rank the PPR ranked/grouped candidate profiles in step 760. The campaign creator/reviewer may decide some candidates are (1) Strong Prospects; (2) Average Prospects; and (3) Poor Prospects. This ranking results in calculation of an Explicit Prospect Rating (EPR), which is based in part on the PPR and in part on the explicit ranking by the campaign creator or other reviewer. Candidates may then be re-ranked or grouped in step 770 based on this EPR, and forwarded on to or displayed for a hiring manager or other like individual in step 780 to conduct follow up communications as needed.

According to another embodiment of the present invention, a method is provided for updating one or more of the algorithms, or weightings used by the algorithms, for calculating the candidate referral rating or the PPR. As an example, the system may compare the PPR with the EPR to identify a PPR rating accuracy. If there is a difference between the PPR and EPR, the system may adjust one or more of the noted algorithms or weightings to improve the PPR rating accuracy. As an example, if the EPR reflects that the campaign creator/reviewer placed more emphasis on the candidate referral rating than a comparison between the candidate profile and the campaign record, then the candidate referral rating may be more heavily weighted. Similarly, if the EPR reflects that the campaign creator/reviewer placed more emphasis on the comparison between the candidate profile and the campaign record, then the comparison may be more heavily weighted. Such a process may be done automatically or manually.

One exemplary technique for updating one or more of the algorithms or weightings comprises use of Baye's theorem. Baye's theorem is directed at updating estimates of conditional probability of a hypothesis given certain evidence (e.g. the probability that a person is a good prospect based on the fact that they were strongly recommended by a coworker), based on the past likelihood of the evidence given the hypothesis (e.g. the probability someone is strongly recommended by a coworker given that they were rated a good prospect).

Baye's theorem can be written as follows:
P(H|E)=P(E|H)×P(H)/P(E)

As written above, Baye's theorem says that the probability of a particular hypothesis given a particular item of evidence can be computed based on the probability of the evidence given the hypothesis in past instances, times a normalization factor: the probability of the hypothesis divided by the probability of the evidence. For a more thorough discussion, see http://en.wikipedia.org/wiki/Bayesian_analysis.

Baye's theorem may be applied to PPR computations by dividing each factor in the equation by a scaling factor to convert it to a probability between 0 and 1 and viewing it as an initial estimate of conditional probability. A so called “naive Bayesian classifier” makes the simplifying assumptions that each of the conditional probabilities is independent. Under this assumption, the probability of the hypothesis Hᵢ given a set of items of evidence Eⱼ can be computed as the product of P(Hᵢ|Eⱼ) for each j. The most likely hypothesis is the one that maximizes this product; this is called the maximum a posteriori (MAP) probability. Although the independence assumption is often violated, it can be proven in a number of cases that the hypothesis chosen through MAP is nonetheless the most likely one.

In brief, Baye's theorem provides a way to update the weightings (conditional probabilities) in the algorithm(s) based on past results, and to compute an improved classification of a prospect based on the evidence. Other techniques also exist for updating the algorithm(s) and/or weighting(s), as would be readily apparent to one of ordinary skill in the art after reading this disclosure.

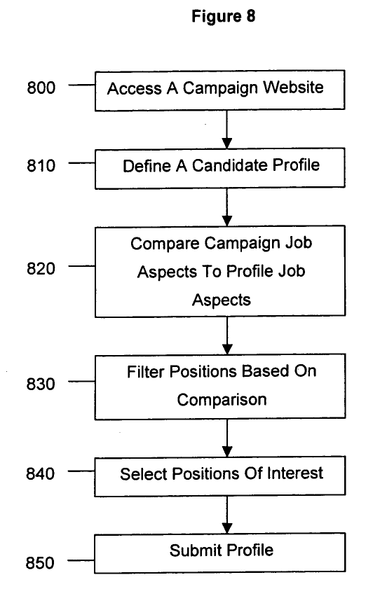

According to yet another embodiment of the present invention, a method of selecting positions for a candidate is provided. Preferably, a campaign is created as similarly described in step 100, such that the campaign includes at least one defined job aspect. Once the job has been created, a user may access a campaign website or the like in step 800 (FIG. 8). As an example, a user may use a browser to access a job postings website such as www.Monster.com. The user then in step 810 defines a candidate profile that includes information about the candidate. Step 810 can be performed in a manner as previously described in reference to candidate and referrer profile creation and maintenance.

In step 820, the system compares campaign job aspects (defined in step 100) to the candidate's preferred job aspects from the candidate profile (defined in step 810). This comparison may be done automatically (e.g., each time a user accesses the campaign website in step 800), in response to an event (e.g., when a new campaign is created in step 100), and/or in response to user query (e.g., the user selecting a search feature on the job postings website). The comparison in step 820 provides a list of jobs from campaigns that are filtered in step 830 and displayed for the user. The user than can select positions of interest in step 840 (or alternatively forward the results on to another individual or recommend another individual), and submit their profile in step 850. In this manner, a user can also benefit from the teachings of the present invention by directly investigating campaigns on a job postings website.

According to another embodiment of the present invention, an interface is provide for integrating a system that identifies candidates for a position with other systems. As an example, an XML interface may be provided for integrating with an Applicant Tracking System. Such a system would be understood by those of skill in the art after reading this disclosure.

A system useable with various embodiments of the present invention is shown in the block diagram of FIG. 9. As shown, the system includes a web server 910 with access to a database 900. Candidate and referrer profiles may be stored in database 900, along with campaign information and any other data used to perform functions of the system. The Web server 810 is in communication with terminals 930, 940, 950 via the internet or other communication means. While only three terminals 930, 940, 950 and one web server 910 are shown, it should be appreciated that multiple terminals and/or multiple servers may be provided.

Preferably, each of terminals 930, 940, 950 and web server 910 include a programmable microprocessor with appropriate peripheral devices including network communication equipment to perform the various method steps described in the aforementioned embodiments. Those of skill in the art will appreciate that the present invention may be provided on many different types of processors (e.g., Intel, AMD, etc.) and in multiple formats (e.g., Macintosh, Windows, Linux) including web based communication protocols and languages. Thus, the system shown in FIG. 9 is exemplary and adaptable to many different variations as may be required for differing implementations.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A method of tracking candidate referrers, comprising:
receiving a candidate referral from a referrer;
monitoring activity involving the candidate referral; and
updating a referrer rating of the referrer based on the monitored activity.

2. The method of claim 1, wherein monitoring activity involving the candidate referral comprises at least one of:
monitoring a hiring rate of referred candidates;
monitoring an interview rate of referred candidates; and
monitoring a review rate of referred candidates.

3. The method of claim 1, further comprising:
maintaining a referrer profile for each of a plurality of referrers,
wherein the referrer profile includes the referrer rating for the referrer.

4. The method of claim 3, wherein the referrer profile further includes contact information for the referrer.

5. The method of claim 3, wherein maintaining the referrer profile comprises tracking a chain of connections to each referrer.

6. The method of claim 3, wherein maintaining the referrer profile comprises prompting the referrer to update the referrer profile when acting on campaign information.

7. The method of claim 6, wherein acting on campaign information comprises at least one of:
forwarding the campaign information; sending the candidate referral; and
submitting a candidate profile for a position specified in the campaign information.

8. The method of claim 6, wherein a campaign comprises a record containing at least a job description; a candidate requirement; and a contact for the campaign.

9. The method of claim 1, further comprising sending campaign information to the referrer.

10. The method of claim 9, wherein sending campaign information to the referrer comprises at least one of:
transmitting a campaign email to the referrer; and
appending campaign information as a signature to a message addressed to the referrer.

11. The method of claim 9, further comprising personalizing campaign information for the referrer.

12. The method of claim 11, wherein personalizing campaign information for the referrer comprises:
sending a personalized message to the referrer; and
at least one of:
drafting a personalized message for the referrer;
selecting one of a previously sent message and a template message for the referrer; and
automatically generating a message based on a referrer profile for the referrer.

13. The method of claim 1, further comprising at least one of:
posting campaign information as a banner advertisement on a Web site; and
posting campaign information on a job postings Web page.

14. A referrer tracking system, comprising:
a database containing a plurality of referrer profiles;
a referral manager adapted and configured to track referral histories of referrers; and
a controller adapted and configured to update the referrer profiles contained in the database with information from the referral manager.

15. The system of claim 14, wherein a referral history comprises at least one of:
a hiring rate of referred candidates;
an interview rate of referred candidates; and
a review rate of referred candidates.

16. The system of claim 14, wherein the referral manager is further adapted and configured to track a chain of connections to each referrer.

17. The system of claim 14, wherein the referral manager is further adapted and configured to prompt referrers to update their referrer profile when acting on campaign information.

18. The system of claim 17, wherein acting on campaign information comprises at least one of:
submitting a referral in response to campaign information;
forwarding campaign information to a candidate prospect; and
submitting a candidate profile in response to campaign information.

19. A referrer tracking system, comprising:
means for tracking referrer profiles in a database;
means for tracking referral histories of referrers; and
means for updating the database with information from the means for tracking.

20. The system of claim 19, wherein the means for tracking comprises at least one of:
means for tracking a hiring rate of referred candidates;
means for tracking an interview rate of referred candidates; and
means for tracking a review rate of referred candidates.
